(19) United States
(12) Patent Application Publication
(10) Pub. No.: US 2025/0005929 A1
(43) Pub. Date: Jan. 2, 2025

(54) CONTENT-AWARE PARTITIONING OF VIDEO FRAMES

(71) Applicant: ADVANCED MICRO DEVICES, INC., Santa Clara, CA (US)

(72) Inventor: Jonathan Philip Bonsor-Matthews, Santa Clara, CA (US)

(21) Appl. No.: 18/217,250

(22) Filed: Jun. 30, 2023

(51) Int. Cl. G06V 20/40; G06V 10/25; G06V 10/26

(52) U.S. Cl. CPC G06V 20/46; G06V 10/25; G06V 10/26

(57) ABSTRACT

A portable electronic device includes a video encoder. The video encoder is configured to receive a video frame. Responsive to the video frame including at least one of a salient object or a region of interest, the video encoder is further configured to partition the video frame into one or more tiles based on a location of the at least one of the salient object or the region of interest.

### BACKGROUND

For many applications, such as video gaming, video streaming, and videoconferencing, transmitting and storing video data require large amounts of bandwidth and memory capacity due to user demand for relatively high quality. Video compression and encoding techniques are sometimes employed to reduce the bandwidth necessary to transmit video and reduce the memory capacity required to store video. One example of a video encoding technique is tiling, where a video frame is divided into smaller independent units called tiles. Each tile can be encoded and decoded separately, which improves the parallelism and efficiency of the encoding process.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a video encoding and decoding (codec) system employing content-aware partitioning of video frames in accordance with some implementations.

FIG. 2 is a block diagram illustrating a detailed view of a content-aware partitioner of the video codec system of FIG. 1 in accordance with some implementations.

FIG. 3 is a block diagram illustrating a more detailed view of a prediction unit from the content-aware partitioner of FIG. 2 in accordance with some implementations.

FIG. 4 is a diagram illustrating a machine learning (ML) module employing a neural network for use in a content-aware partitioning neural network architecture implemented by the content-aware partitioner of FIG. 3 in accordance with some implementations.

FIG. 5 illustrates an example of a video frame comprising salient and non-salient objects in accordance with some implementations.

FIG. 6 illustrates an example of the video frame of FIG. 5 after content-aware partitioning has been performed thereon in accordance with some implementations.

FIG. 7 is a flow diagram illustrating a method for performing content-aware partitioning on a video frame in accordance with some implementations.

### DETAILED DESCRIPTION

Tiling is a video encoding technique that spatially partitions each video frame of a video file (or stream) into multiple smaller tiles, each of which can be encoded and decoded independently. Each of the tiles can be further divided into smaller blocks. Tiling is typically used in combination with other video encoding techniques, such as motion estimation and compression. Motion estimation is the process of determining how individual pixels in a video frame are moving, and compression is the process of reducing the size of the video data. When video frames are tiled, each tile can be encoded using a different compression algorithm, which significantly reduces the amount of data required to store the video. Tiling can improve video compression efficiency by reducing the amount of data that needs to be encoded for each frame. For example, if a video frame is divided into four tiles, each tile only needs to be encoded once, even if the tile includes multiple moving objects, which reduces the overall size of the video file. Tiling can also speed up the encoding and decoding processes by allowing different parts of the video to be encoded and decoded in parallel. For example, if a video frame is divided into four tiles, four different processes or processors can be used to encode (and decode) each tile at the same time, which reduces the time it takes to encode and decode a video file.

Although tiling provides advantages, such as improved encoding speed, reduced decoding latency, and increased accessibility, over non-tiling-based encoding techniques, tiling has some disadvantages that may affect video quality and performance. For example, one of the main issues encountered with tiling is the introduction of artifacts into the video across the tile (or block) boundaries. For example, in some instances, tiling introduces boundary artifacts (also referred to herein as spatial artifacts) at the edges of the tiles, especially when using high compression or low bitrates, due to differences in encoding techniques on either side of the boundary. Also, if tiles are divided on a finer level into blocks, further blocking artifacts may be present around the block divisions. Examples of boundary artifacts include blocking and color bleeding. Blocking occurs when a compressed image comprised of tiles is streamed over a low bandwidth. For example, when block-based encoding is applied to pixels within a tile (or block), the transform coefficients of each tile are quantized. The low-frequency content typically remains after quantization, which results in blurry, low-resolution tiles or blocks, resulting in discontinuities being observed by a user near the edges of neighboring tiles or blocks. Color bleeding occurs when the edges of one color in the video frame unintentionally bleed or overlap another color. Color bleeding is typically caused by poor prediction across an edge. Other spatial artifacts include basis pattern artifacts (e.g., poor representation of detail), blurring artifacts (e.g., loss of high frequencies if an object's edge is near a block/tile edge), ringing artifacts (e.g., banding near sharp object edges), staircase artifacts (e.g., discontinuities in the apparent quantization for diagonal object edges), and the like.

In many instances, a video frame includes areas with content of interest or higher priority to the user viewing the video frame compared to the content in other areas of the frame. For example, some areas of the video frame may include an object or region of interest, such as a main character or a main focal point in a game or movie, whereas other areas of the video frame may include objects or regions, such as background objects, that are not of particular interest, or of a lower priority, to the user. However, video encoders typically analyze an incoming stream of images solely based on the pixel data and, therefore, usually cannot identify or detect areas of a video frame that include objects or regions of interest. This limitation of video encoders results in the tiling process being performed without regard to the content of the video frame. As such, tiling performed by video encoders often introduces artifacts, such as the boundary artifacts described above, within key objects or regions of interest in a video frame. This is problematic from a user's perspective since the user is likely more focused on objects or regions of interest than the surrounding parts of the image, making the artifacts more noticeable.

Accordingly, the present disclosure describes implementations of systems and methods for content-aware partitioning of video frames that address the abovementioned problems associated with conventional video frame partitioning techniques. In at least some implementations, a video encoder uses knowledge of salient objects, or regions of interest (ROIs), within a video frame to improve the partitioning or sub-division of that frame such that unwanted artifacts within those salient objects or regions are reduced or eliminated and to improve the encoding of the frame. For example, the video encoder identifies one or both salient objects or ROIs within a video frame and uses this content awareness when determining the frame-to-tile divisions, tile-to-block divisions, or a combination thereof. By partitioning a video frame such that salient objects or ROIs are maintained within the same tile (or block), boundary artifacts are reduced or less noticeable within these partitioned areas.

As described in greater detail below, the video encoder implements one or more mechanisms for detecting or identifying salient objects and ROIs within a video frame. For example, in at least some implementations, the video encoder implements an application programming interface (API) that allows the video encoder and a video source, such as a video game application, to communicate with each other. The video source sends metadata to the video encoder associated with each video frame. The metadata identifies regions/areas of a video frame that include salient objects or ROIs. For example, in at least some implementations, the metadata identifies the locations (e.g., pixel locations) of salient objects or ROIs within the video frame, the shapes of the salient objects, a combination thereof, or the like. Alternatively, or additionally, the video encoder, in at least some implementations, implements a frame-based object detection/tracking mechanism, which is advantageous for content where salient objects or ROIs are not pre-identified by the video source, such as in natural camera content. The frame-based object detection/tracking mechanism, in at least some implementations, uses machine learning to analyze a video frame to detect or identify specific object types or shapes within the video frame.

After the video encoder has identified salient objects or ROIs using the techniques described herein, the video encoder partitions the video frame into one or more tiles such that an identified object/ROI is included within a single tile in its entirety, or at least a majority of the object/ROI is included within a single tile, and does not span across multiple tiles. In at least some implementations, two or more identified objects/ROIs are grouped into the same tile(s) (or block). The video encoder, in at least some implementations, further partitions the tiles into smaller units, referred to as blocks using the content-aware partitioning techniques described herein. By partitioning the video frame into tiles (and blocks) in a content-aware fashion, the video encoder minimizes compression artifacts occurring within an object or ROI itself, which improves the quality of video perceived by the end-viewer. Also, by grouping objects together within divisions (either tiles or blocks), more efficient compression is achievable for the same level of quality since, for example, the objects are more likely to share similarities in terms of colors, motion vectors, textures, etc.

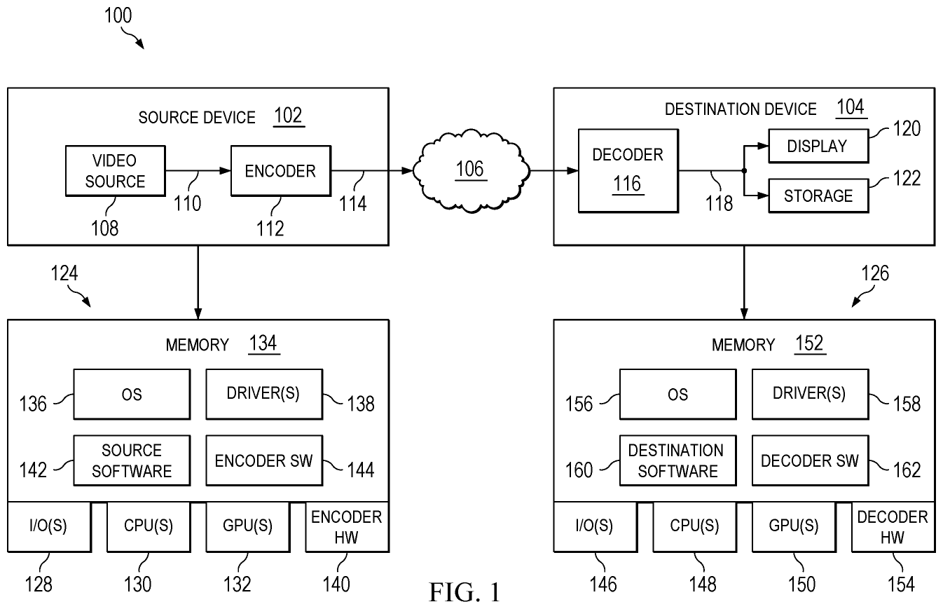

FIG. 1 illustrates a video coding system 100 employing content-aware partitioning of image data (e.g., video frames) in accordance with some implementations. The video coding system 100 includes a source processing device 102 (also referred to herein as “source device 102”) connected to a destination processing device 104 (also referred to herein as “destination device 104”) via a connection 106. The source device 102 includes any of a variety of devices or systems used to encode a video stream, whether generated at the source device 102 or received at the source device 102 from another device in encoded or unencoded form. The destination device 104 includes any of a variety of devices or systems used to decode the video stream encoded by the source device 102, whether for consumption at the destination device 104 or for forwarding on to yet another device in encoded or decoded form. In at least some implementations, the source device 102 also acts as the destination device 104 for decoding and rendering the encoded video data generated by the source device 102.

The connection 106, in at least some implementations, includes any of a variety of wired or wireless connections, or a combination thereof, such as a wired cable, a wireless network connection, a wired network connection, the Internet, and the like. For example, the source device 102, in at least some implementations, includes a server that operates to encode camera-captured video content, computer-rendered content, or a combination thereof, for transmission to the destination device 104 in the form of a smartphone, a compute-enabled vehicle entertainment system, a compute-enabled appliance, a tablet computer, a laptop computer, a desktop computer, a video game console, a television, and the like. As another example, each of the source device 102 and the destination device 104 include a smartphone, a wearable computing device, a tablet computing device, a laptop computer, a desktop computer, a video game console, a television, and the like. Moreover, it will be appreciated that the destination device 104 may operate as a source device and the source device 102 operate as a destination device for the encoding and decoding of a video stream transmitted in the other direction.

As a general operational overview, a video (or image) source 108 of the source device 102 operates to generate a sequence 110 of video frames. For example, the video source 108 can include a camera capturing video frames, a video game application, a video conferencing application, a remote desktop sharing application, or another computer application that generates a sequence of video frames, either from camera capture, computer rendering, or a combination thereof. In another example, the video source 108 generates a single video/image frame. An encoder 112 encodes the sequence 110 of video frames or the single video/image frame, along with any associated audio data and metadata, generating an encoded bitstream 114 that is transmitted to the destination device 104 via the connection 106. At the destination device 104, a decoder 116 decodes the encoded bitstream 114 to generate a recovered sequence 118 of video frames, which then may be presented at a display 120, stored at a storage device 122, re-encoded for transmission to yet another device or for storage, and the like.

Views 124 and 126 illustrate example hardware configurations for the source device 102 and the destination device 104, respectively. As shown by view 124, the source device 102 includes one or more input/output (I/O) devices 128, including an interface for interfacing with the connection 106 (e.g., a network interface for a network connection, a cable interface for a cable connection, etc.). The source device 102 further includes one or more central processing units (CPUs) 130, one or more accelerated processing devices (APD), such as a graphics processing unit (GPU) 132, and one or more memories 134. The CPU 130 and GPU 132 (or other APD) each include one or more processing cores (not shown). Each of the one or more processing cores executes a respective instantiation of a particular work item to process incoming data, where the basic unit of execution in the one or more processing cores is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing core.

The source device 102 further includes encoder hardware 140 for performing some or all of the content-aware partitioning processes described herein and encoding processes. The encoder hardware 140, in at least some implementations, includes one or more of the CPUs 130, one or more of the APDs, such as the GPUs 132, or a combination thereof. Alternatively, in at least some implementations, the encoder hardware 140 includes encoder-specific hardware, such as one or more application-specific integrated circuits (ASICs), one or more programmable logic devices, and the like, or a combination thereof. In other implementations, the encoder hardware 140 includes a combination of one or more CPUs 130, GPUs 132, or a combination thereof, as well as encoder-specific hardware, such as one or more ASICs, one or more programmable logic devices, or a combination thereof. Other hardware components typically implemented at video codec devices, such as speakers, microphones, power supplies, busses, power managers, etc., are omitted for clarity.

The one or more memories 134 include one or more types of memory, such as random access memory (RAM), read-only memory (ROM), Flash memory, hard disc drives, register files, and the like, and store one or more sets of executable instructions that, when executed by the one or more CPUs 130 and/or the one or more GPUs 132, manipulate the hardware of the source device 102 to perform the functionality ascribed to the source device 102 herein. In particular, the executable instructions can implement an operating system (OS) 136 for overall control and coordination of the hardware components of the source device 102, device drivers 138, such as graphics drivers, for coordination and control of the one or more GPUs 132 by the one or more CPUs 130, and a video source application/software 142. The video source application 142 represents the video source 108 in that it coordinates with the OS 136 and device drivers 138 to control the one or more CPUs 130 and the one or more GPUs 132 to capture, render, or otherwise generate the sequence 110 of video frames. To illustrate, the video source application 142 can include a video conference application, a remote desktop application, a wireless display application, a cloud gaming application, a video streaming application, and the like. In some implementations, the executable instructions further include encoder software 144 that executes to manipulate the encoder hardware 140 (which may include one or more CPUs 130 and/or one or more GPUs 132) to perform the content-aware partitioning processes described herein and one or more encoding processes. That is, the encoder 112 is implemented at least in part by one or more processors that execute software to perform at least some of the content-aware partitioning processes described herein and one or more encoding processes. As such, the encoder software 144, in at least some implementations, is implemented in whole or in part as a device driver, such as a graphics driver, as part of the video source application 142, as part of the OS 136, or a combination thereof. In other implementations, the content-aware partitioning processes described herein and one or more encoding processes are implemented entirely in application-specific hardware, such as one or more ASICs or one or more programmable logic devices.

As shown by view 126, the destination device 104, in at least some implementations, includes a hardware configuration similar to the source device 102. As such, the destination device 104, in at least some implementations, includes one or more I/O devices 146, including an interface for interfacing with the connection 106, one or more CPUs 148, one or more APDs, such as a GPU 150, and one or more memories 152. The destination device 104 further includes decoder hardware 154 for performing one or more decoding processes. As with the encoder hardware 140, the decoder hardware 154, in at least some implementations, includes one or more of the CPUs 148, one or more of the GPUs 150, one or more ASICs, one or more programmable logic devices, or a combination thereof. Other hardware components typically implemented at video codec devices, such as speakers, microphones, power supplies, busses, power managers, etc., are omitted for clarity. Depending on the implementation, the destination device 104 further includes one or more components for “consuming” the decoded sequence 118 of video frames, such as the display 120 or the storage device 122.

The one or more memories 152 include one or more types of memory and store one or more sets of executable instructions that, when executed by the one or more CPUs 148 and/or the one or more GPUs 150, manipulate the hardware of the destination device 104 to perform the functionality ascribed to the destination device 14 herein. In particular, the executable instructions can implement an OS 156 for overall control and coordination of the hardware components of the destination device 104, device drivers 158, such as a graphics driver, for coordination and control of the one or more GPUs 150 by the one or more CPUs 148, and a video destination application 160. The video destination application 160 represents the video destination in that it coordinates with the OS 156 and device drivers 158 to control the one or more CPUs 130 and the one or more GPUs 132 to consume the decoded sequence 118 of video frames, either by a presentation at the display 120, storage at the storage device 122, re-encoding by an encoder (not shown), and the like. To illustrate, the video destination application 160 can include a video conference application, a remote desktop application, a wireless display application, a client gaming application, a video streaming application, and the like.

In some implementations, the executable instructions further include decoder software 162 that executes to manipulate the decoder hardware 154 (which may include one or more CPUs 148 and/or one or more GPUs 150) to perform one or more decoding processes described herein. That is, the decoder 116 is implemented at least in part by one or more processors that execute software to perform one or more decoding processes. As such, the decoder software 162, in at least some implementations, is implemented in whole or in part as a device driver, such as a graphics driver, as part of the video destination application 160, as part of the OS 156, or a combination thereof. In other implementations, one or more decoder processes are implemented entirely in application-specific hardware, such as one or more ASICs or one or more programmable logic devices.

In at least some implementations, the encoder 112 partitions a video frame, which can be a standalone video/image frame or a video frame of the sequence 110 of video frames, into two or more smaller units called tiles, and each tile can be further partitioned into even smaller units called blocks. Each tile (or block) includes a first number of pixels in a first (e.g., vertical) direction and a second number of pixels in a second (e.g., horizontal) direction. The encoder 112, in at least some implementations, selects a suitable encoding mode for each tile (or block), such as a prediction mode (e.g., inter-prediction or intra-prediction), quantization parameters, tiling parameters, and the like. Each tile (or block) is then encoded based on the selected encoding mode and inserted into the encoded bitstream 114 destined for reception by a destination device 104. The decoder 116 similarly employs one or more complementary decoding modes for decoding the encoded video frames of the encoded bitstream 114 on the same frame or block-partition basis. Partitioning the video frame into tiles (or blocks) allows the encoder 112 to implement multiple encoding processes to encode each of the tiles in parallel and further allows the decoder 116 to implement multiple decoding processes to decode each of the tiles in parallel.

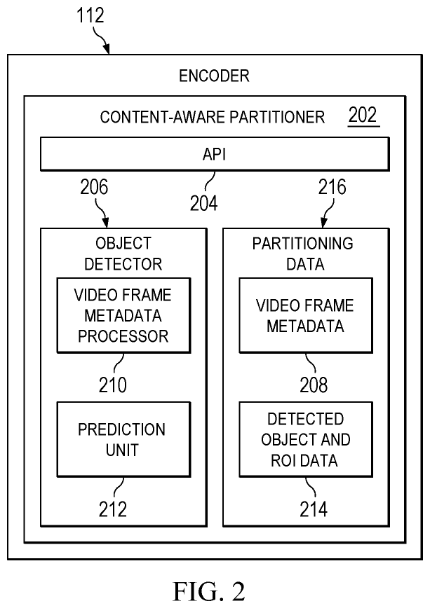

As described above, encoding tiles can introduce boundary artifacts at the edges of the tiles, especially when using high compression or low bitrates, due to differences in encoding techniques on either side of the boundary. Also, if tiles are divided on a finer level into blocks, further blocking artifacts may be present around the block divisions. In many instances, the boundary artifacts occur within salient objects or ROIs in the video frame. Since a user is likely to be more focused on these salient objects or ROIs than the surrounding parts of the image, the artifacts become increasingly noticeable to the user. Therefore, as shown in FIG. 2, the encoder 112 comprises a content-aware partitioner 202 that uses knowledge of salient objects or regions of interest (ROIs) within a video frame to improve the partitioning or sub-division of that frame such that unwanted artifacts within those salient objects and ROIs are reduced or eliminated. For example, as described below, the encoder 112 identifies one or both of salient objects or ROIs within a video frame and uses this content awareness when determining the frame-to-tile divisions, tile-to-block divisions, or a combination thereof. By partitioning a video frame such that salient objects or ROIs are maintained within the same tile (or block), boundary artifacts are reduced or less noticeable within these partitioned areas. The content-aware partitioner 202, in at least some implementations, is implemented as one or more of the CPUs 130, one or more of the GPUs 132, one or more ASICs, one or more programmable logic devices, or a combination thereof. In other implementations, the content-aware partitioner 202 is implemented as software executable on one or more of the CPUs 130, one or more of the GPUs 132, or a combination thereof.

In at least some implementations, the content-aware partitioner 202 includes an application programming interface (API) 204 and an object detector 206. The API 204 allows the encoder 112 to communicate with the video source 108 (or an application associated therewith) to receive video frame metadata 208 associated with each video frame of the sequence 110. For example, the video source 108 (or an application associated therewith), in at least some implementations, sends metadata 208 in conjunction with the video frame to the encoder 112 through the API 204. In at least some implementations, the metadata 208 identifies one or both of salient objects or ROIs within the video frame associated with the metadata 208. A salient object, in at least some implementations, is defined as a discrete object in the video frame that is of interest to the viewer or is one of the main focal points of the frame, such as the main character (or at least a portion thereof) of a video game. An ROI, in at least some implementations, is defined as an area or region in the video frame that is of interest to the viewer or is one of the main focal points of the frame, such as a specific area of a video game that a user is focused on or that character's point-of-view is directed to. In at least some implementations, an ROI is a region or area within the video frame comprising a salient object.

In at least some implementations, the metadata 208 includes the location data of salient objects and ROIs in the video frame, the shapes of the salient objects, a combination thereof, or the like. The location data, in at least some implementations, includes position coordinates of the pixels within the frame comprising the salient objects or ROIs. The shapes of salient objects include, for example, bounding rectangles (e.g., four corner coordinates, two coordinates (e.g., top-left, bottom-right, etc.), and the like), a list of macroblocks, and other similar mechanisms to allow an encoder 112 to identify whether a pixel is within or outside the shape. The shapes of salient objects, in at least some implementations, are indicated to the encoder 112 by, for example, an API, storing frame metadata (e.g., shape data) in memory (of any type), a direct hardware connection, and the like. The content-aware partitioner 202 of the encoder 112 uses the shape information indicated using the metadata 208 to determine where in the video frame a partition should occur and should not occur. The object detector 206, in at least some implementations, includes a metadata processor 210 that processes the video frame metadata 208 and informs the content-aware partitioner 202 of object or ROI locations within the video frame. The object detector 206, in at least some implementations, is implemented as one or more of the CPUs 130, one or more of the GPUs 132, one or more ASICs, one or more programmable logic devices, or a combination thereof. In other implementations, the object detector 206 is implemented as software executable on one or more of the CPUs 130, one or more of the GPUs 132, or a combination thereof.

In some instances, metadata identifying the salient objects or ROIs is not available for the video frame, such as with some natural camera content or internal context and data of some video games. Therefore, in at least some implementations, the content-aware partitioner 202 comprises a prediction unit 212 to predict or infer the locations of salient objects or ROIs in a video frame. The prediction unit 212, in at least some implementations, is a data-driven prediction unit that is artificially intelligent and capable of performing machine learning tasks. In at least some implementations, the prediction unit 212 is implemented separately from or as part of one or more of the CPUs 130, one or more of the GPUs 132, one or more ASICs, one or more programmable logic devices, or a combination thereof. In other implementations, the prediction unit 212 is implemented as software executable on one or more of the CPUs 130, one or more of the GPUs 132, or a combination thereof. As described in greater detail below, the prediction unit 212 receives a video frame, which can be a standalone video/image frame or a video frame of the sequence 110 of video frames, and predicts or infers the locations of one or both of salient objects or ROIs in the video frame. The prediction unit 212 passes an inference output to the content-aware partitioner 202 that includes an indication/identification of detected salient objects, ROIs, or a combination thereof and their locations in the video frame. In at least some implementations, the content-aware partitioner 202 stores the inference output as a detected object and ROI data 214. As described in greater detail below, the content-aware partitioner 202 uses the detected object and ROI data 214 to determine how to partition (e.g., tile) the video frame.

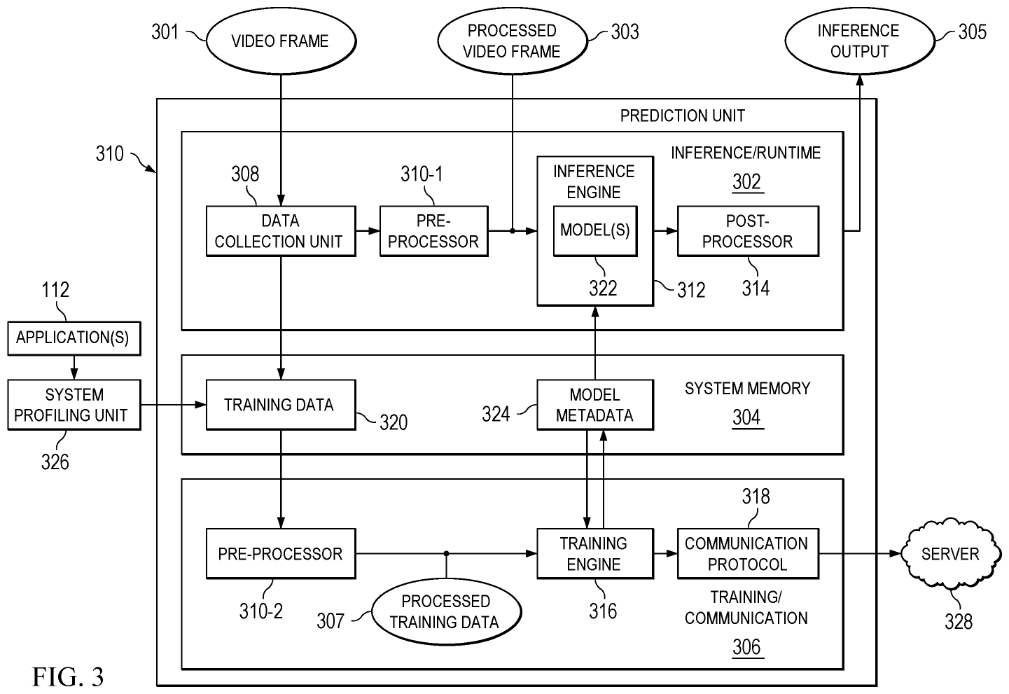

FIG. 3 illustrates an example of a more detailed view of the prediction unit 212. It is noted that the number of components of the prediction unit 212 varies from implementation to implementation. In at least some implementations, there is more or fewer of each component/subcomponent than the number shown in FIG. 3. It is also noted that the prediction unit 212, in at least some implementations, includes other components not shown in FIG. 3. Additionally, in other implementations, the prediction unit 212 is structured in other ways than shown in FIG. 3. Also, components of the prediction unit 212 are implemented as hardware, circuitry, firmware, software, or any combination thereof.

In the example shown in FIG. 3, the prediction unit 212 includes an inference/runtime pipeline 302, at least a portion 304 of the system memory 134, and a training/communication pipeline 306. The inference/runtime pipeline 302 includes a data collection unit 308, a pre-processor 310 (illustrated as pre-processor 310-1), an inference engine 312, and a post-processor 314. The training/communication pipeline 306, in at least some implementations, includes a pre-processor 310 (illustrated as pre-processor 310-2), a training engine 316, and a communication protocol unit 318. It is noted that the prediction unit 212, in at least some implementations, includes other components not shown in FIG. 3, includes components different from those shown in FIG. 3, or does not include one or more of the components shown in FIG. 3.

The data collection unit 308 receives one or more video frames 301 being encoded from the encoder 112, the memory 134, directly from the video source 108 or an application associated therewith, or the like. In at least some implementations, a copy of a received video frame 301 is stored in a portion 304 of the system memory 134 as training data 320. If a pre-processor 310-1 is implemented in the inference/runtime pipeline 302, the video frame(s) 301 is passed to the pre-processor 212-1. The pre-processor 212-1 performs one or more pre-processing operations to output a representation of the video frame(s) 301 (illustrated as processed video frame 303) that is consumable by the inference engine 312.

The inference engine 312, in at least some implementations, is an artificial intelligence engine that implements one or more machine learning-based models 322 (also referred to herein as trained models 322). In at least some implementations, the inference engine 312 is implemented separate from or as part of one or more of the CPUs 130, one or more of the GPUs 132, one or more ASICs, one or more programmable logic devices, or a combination thereof. In other implementations, the inference engine 312 is implemented as software executable on one or more of the CPUs 130, one or more of the GPUs 132, or a combination thereof. As described below, the machine learning model(s) 322 is trained to detect or predict salient objects, ROIs, and their locations in the video frame 301. In at least some implementations, the inference engine 312 takes as input the processed video frame 303. However, in other implementations, the inference engine 312 takes the unprocessed video frame 301 as input. In at least some implementations, the inference engine 312 also takes model metadata 324 as input. The model metadata 324 includes a model architecture(s), learned weights, any runtime settings, and the like for one or more machine learning models 322 implemented by the inference engine 312. The model metadata 324 includes information used by the inference engine 312 for both local function fitting (e.g., fine-tuning a neural network) and local inference.

In at least some implementations, the model metadata 324 is generated/determined based on a training process performed by the training engine 316. For example, the training engine 316 takes as input the training data 320 stored in the portion 304 of the system memory 134. It should be understood that although FIG. 3 shows the training data 320 as being stored in a portion 304 of the system memory 134. However, in other implementations, at least a portion of the training data 320 is stored in another location on the source device 102, in a location remote from the source device 102, a combination thereof, or the like. The training data 320, in at least some implementations, includes one or more instances of video frames that have salient objects, one or more instances of video frames that have ROIs, one or more instances of video frames that do not have salient objects, one or more instances of video frames that do not have ROIs, and the like. If a pre-processor is implemented in the training/communication pipeline 306, the training data 320 is processed by a pre-processor 212-2 prior to being received by the training engine 316. For example, the pre-processor 212-2 performs one or more pre-processing operations to output a representation of the training data 420 (illustrated as processed training data 307) that is consumable by the training engine 316. In other implementations, the training data 320 is not pre-processed.

The training engine 316 takes as input the processed training data 307 (or unprocessed training data 320) and current model metadata 324 and proceeds to fine-tune the current model metadata 324 based on the processed training data 307 or unprocessed training data 320 (e.g., local data) using one or more machine learning techniques. In at least some implementations, at least part of training or fine-tuning the model metadata 324 includes performing one or machine learning techniques, such as supervised learning, unsupervised learning, reinforcement learning, semi-supervised learning, self-supervised learning, multi-instance learning, statistical inference (e.g., inductive learning, deductive inference, transductive learning, and the like), multi-task learning, active learning, online learning, transfer learning, ensemble learning, or the like to configure the model(s) 322 for training/configuring the models 322 and determining/predicting salient objects, ROIs, and their locations in a video frame. During the training process, the model 322 being trained learns to detect objects of specific types, object shapes, regions of a frame that are considered ROIs given the context of the content in the video frame, and the like. In at least some implementations, the model 322 being trained also learns how to track an object detected in one video frame across one or more subsequent frames to determine if that object is a salient object or a non-salient object.

For example, in a configuration where the training engine 316 implements supervised learning to learn object detection for salient object and ROI, the model 322 being trained takes training data 320, including video frames with objects labeled as salient or non-salient and regions labeled as ROIs or non-ROIs. Based on this training data, the model 322 learns to detect objects and regions within a video frame and also learns to determine whether an object is salient or non-salient and whether a region is an ROI or a non-ROI. In an example where the training engine 316 implements reinforcement learning to learn object detection for salient objects or region detection for ROIs, the model 322 implements a reward based on, for example, a measure of correctness to guide the model 322 on learning object/ROI detection and predicting whether an object is salient or non-salient or whether a region is an ROI or a non-ROI. For example, the model 322 takes a video frame as training data input and outputs an indication of whether an object was detected and, if an object was detected, the location of the detected object and an indication of whether the object was salient or non-salient. The model 322 also outputs a reward that combines, for example, the object detection and salient predictions with an error or correctness measurement. The reward is then fed back into the model 322, and the model metadata 324 is adjusted accordingly. After the training and fine-tuning are complete for the model 322, the resulting model metadata 324 is then stored back into the portion 304 of system memory 134 to overwrite the previous model metadata 324.

In at least some implementations, the model metadata 324 of a trained model 322 is sent to a remote information processing system (e.g., a server 328) for centralized or federated learning. For example, the communication protocol unit 318 sends the fine-tuned model metadata 324 and training data 320 to a server 328 for centralized learning. In another example, the communication protocol unit 318 sends only the fine-tuned model metadata 324 to the server 328 for federated learning. The server 328, in at least some implementations, sends updated model metadata back to the source device 102, and the prediction unit 212 stores the received model metadata as the current model metadata 324 in the portion 304 of the system memory 134.

As indicated above, the inference engine 312, in at least some implementations, takes an unprocessed video frame 301 (or processed video frame 303) and model metadata 324 as input. The inference engine 312 uses the model metadata 324 to configure a corresponding model 322 for locally performing inference on the processed video frame 303 (or unprocessed video frame 301) or using a runtime engine. For example, the inference engine 312 configures the one or more models 322 using the model metadata 324 and inputs the processed video frame 303 (or unprocessed video frame 301) into the configured model(s) 322. The model(s) 322 performs one or more inference operations on the unprocessed video frame 301 (or processed video frame 303) and generates an inference output 305, including, for example, an indication of whether an object or ROI has been detected. If an object has been detected, the inference output 305 also includes an indication of whether the object is salient or non-salient. If the object is salient or if an ROI has been detected, the inference output 305 further includes location data, such as position coordinates of the pixels within the frame comprising the salient object(s) or ROI(s). In at least some implementations, the location data includes position coordinates of the pixels defining a bounding box encompassing the salient object(s) or ROI(s). The inference output 305, in at least some implementations, is stored by the content-aware partitioner 202 as a detected object and ROI data 214.

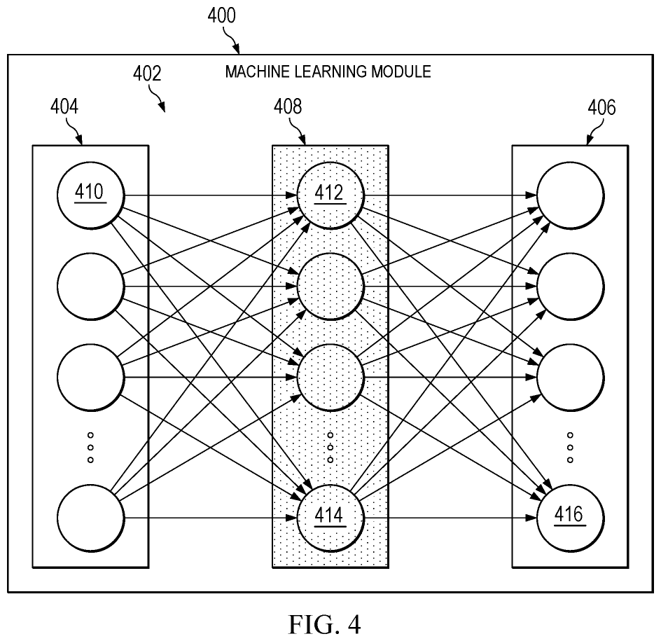

As described above, the automated content-aware partitioner 202 performs one or more machine-learning operations. As such, in at least some implementations, one or more components of the automated content-aware partitioner 202 are machine learning (ML) modules or include an ML module(s) that implement a neural network. FIG. 4 shows one example of an ML module 400 capable of being implemented as or by one or more components of the automated content-aware partitioner 202, such as the prediction unit 212. The ML module 400, in at least some configurations, implements one or more deep neural networks (DNNs) or other neural networks for detecting salient objects and ROIs within a video frame. The ML module 400, therefore, illustrates an example module for implementing one or more of these neural networks.

In the depicted example, the ML module 400 implements at least one deep neural network (DNN) 402 with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based on adaptive learning. Using the DNN 402, the ML module 400 performs a variety of different types of analysis, including single linear regression, multiple linear regression, logistic regression, stepwise regression, binary classification, multiclass classification, multivariate adaptive regression splines, locally estimated scatterplot smoothing, a combination thereof, and so forth.

In some implementations, the ML module 400 adaptively learns based on supervised learning. In supervised learning, the ML module 400 receives various types of input data as training data, such as the training data 320 of FIG. 3. The ML module 400 processes the training data to learn how to map the input to a desired output. As one example, the ML module 400 receives training data, including video frames having or being free of objects, ROIs, or a combination thereof, and learns how to map this input training data to, for example, objects that are considered salient, objects that are considered non-salient, regions that are considered ROIs, regions that are considered non-ROIs, and the like.

During a training procedure, the ML module 400 uses labeled or known data as an input to the DNN 402. The DNN 402 analyzes the input using the nodes and generates a corresponding output. The ML module 400 compares the corresponding output to truth data and adapts the algorithms implemented by the nodes to improve the accuracy of the output data. Afterward, the DNN 402 applies the adapted algorithms to unlabeled input data to generate corresponding output data. The ML module 400 uses one or both of statistical analysis and adaptive learning to map an input to an output. For instance, the ML module 400 uses characteristics learned from training data to correlate an unknown input to an output that is statistically likely within a threshold range or value. This allows the ML module 400 to receive complex input and identify a corresponding output. In some implementations, a training process trains the ML module 400 on characteristics of objects, such as object types and object shapes, and ROIs. This allows the trained ML module 400 to receive video frames as input data specific and determine whether a video frame comprises an object and ROIs and whether a detected object is a salient object or a non-salient object.

In the depicted example, the DNN 402 includes an input layer 404, an output layer 406, and one or more hidden layers 408 positioned between the input layer 404 and the output layer 406. Each layer has an arbitrary number of nodes, where the number of nodes between layers can be the same or different. That is, the input layer 404 can have the same number and/or a different number of nodes as output layer 406, the output layer 406 can have the same number and/or a different number of nodes than the one or more hidden layer 408, and so forth.

Node 410 corresponds to one of several nodes included in input layer 404, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 410 can determine whether to pass the processed input data to one or both of node 412 and node 414 of hidden layer 408. Alternatively or additionally, node 410 passes the processed input data to nodes based upon a layer connection architecture. This process can repeat throughout multiple layers until the DNN 402 generates an output using the nodes (e.g., node 416) of output layer 406.

A neural network can also employ a variety of architectures that determine what nodes within the neural network are connected, how data is advanced and/or retained in the neural network, what weights and coefficients the neural network is to use for processing the input data, how the data is processed, and so forth. These various factors collectively describe a neural network architecture configuration, such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 402 or other neural network processes input data.

A neural network architecture configuration of a neural network can be characterized by various architecture and/or parameter configurations. To illustrate, consider an example in which the DNN 402 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where the neural network pools data in the layers of data processing. A pooling parameter that indicates “max pooling,” for instance, configures the neural network to pool by selecting a maximum value from the grouping of data generated by the nodes of a first layer and using the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 406) to every node in a second layer (e.g., hidden layer 408), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that a DNN can apply that influences how the DNN processes input data to generate output data.

In at least some implementations, the device implementing the ML module 400 locally stores some or all of a set of candidate neural network architectural configurations that the ML module 400 can employ. For example, a component of the automated content-aware partitioner 202 can index the candidate neural network architectural configurations by a look-up table (LUT) or other data structure that takes as inputs one or more parameters, such as a video source identifier, the type of video source providing the video content, the type of video content, a combination thereof, or the like and outputs an identifier associated with a corresponding locally-stored candidate neural network architectural configuration that is suited for operation given the input parameter(s). As such, the ML module 400 allows components of the automated content-aware partitioner 202, such as the prediction unit 212, to perform one or more machine learning operations for detecting salient objects and ROIs within a video frame.

As described above, if video frame metadata 208 has been received for the current video frame being encoded, the object detector 206 processes the video frame metadata 208 and provides the locations of salient objects, ROIs, or a combination thereof, as indicated by the video frame metadata 208, to the content-aware partitioner 202. Alternatively, or in addition, the object detector 206 provides detected object and ROI data 214 generated by the prediction unit 212 to the content-aware partitioner 202. The video frame metadata 208, the detected object and ROI data 214, or a combination thereof, are referred to herein as “partitioning data 218”. The content-aware partitioner 202 uses the information obtained from the partitioning data 218 to partition the video frame such that unwanted artifacts within salient objects or ROIs are reduced or eliminated.

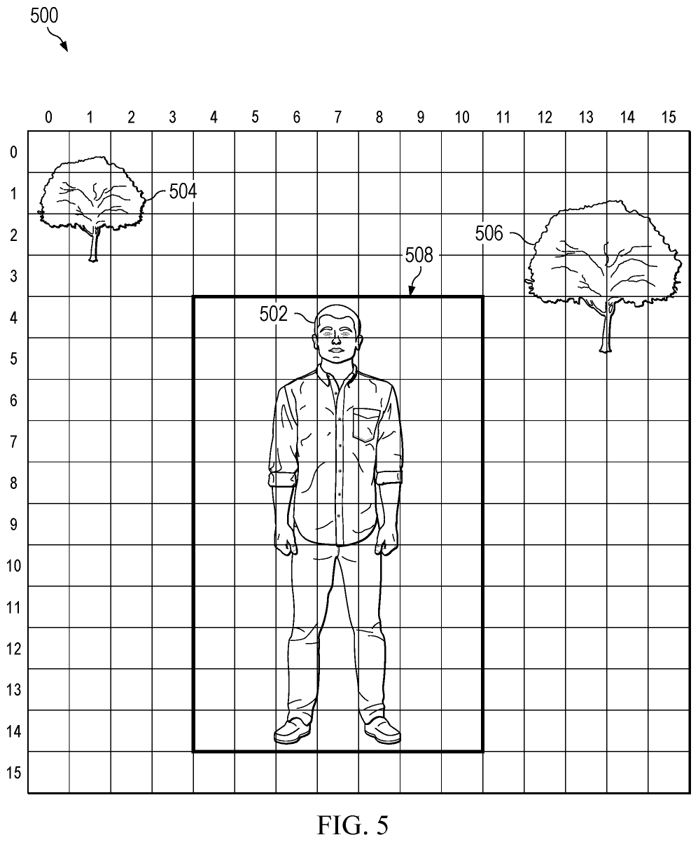

For example, FIG. 5 shows one example of a video frame 500. In this example, the video frame 500 comprises multiple objects 502 to 506, and partitioning data 218 indicates that the first object 502 is a salient object and provides location data for this object in the video frame 500. The partitioning data 218, in at least some implementations, also indicates that the second object 504 and third object 506 as non-salient objects and further provides location data for each of these objects in the video frame 500. In at least some implementations, the location data identifies each pixel of the video frame 500 comprising at least a portion of an identified object. For example, the location data associated with the first object 502 indicates that pixel coordinates (6,4), (7,4) . . . (8,14) comprise the first object 502. In at least some implementations, the location data identifies a bounding box encompassing an identified object. For example, FIG. 5 shows a bounding box 508 encompassing the first object 502. In this example, the location data comprises pixel coordinates defining the bounding box, such as (4,4) to (10,4), (4,4) to (4,14), (10,4) to (10,14), and (4, 14) to (10,14).

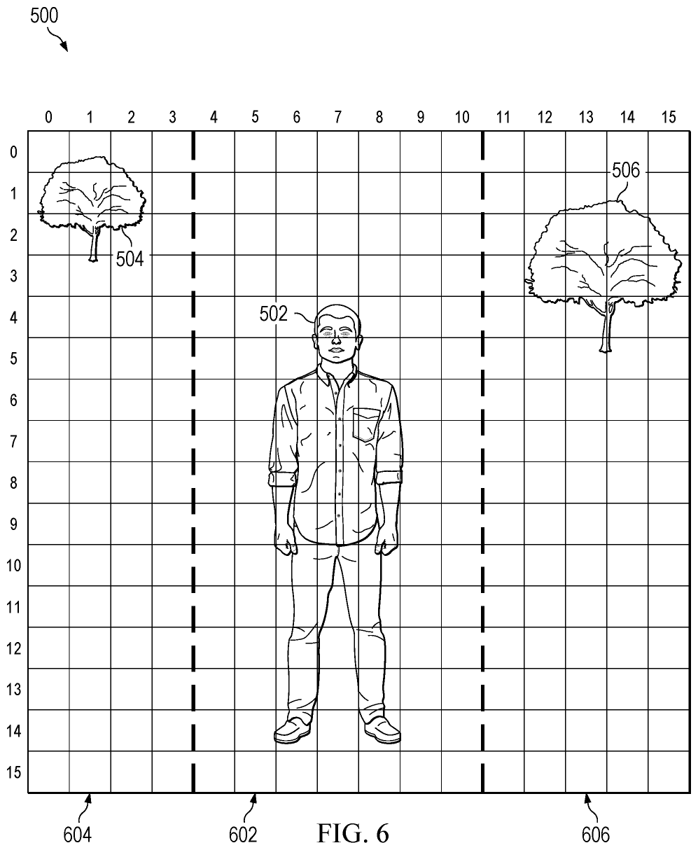

FIG. 6 shows the video frame 500 after the content-aware partitioner 202 performs tiling based on the partitioning data 218. In this example, the content-aware partitioner 202 uses its knowledge of the location of salient objects, such as the first object 502, the content-aware partitioner 202 to divide the video frame 500 into one or more tiles such that the salient objects are grouped into the same tile(s) or within their own tiles. For example, FIG. 5 shows that the content-aware partitioner 202 has partitioned the video frame 500 into three tiles 602 to 606, such that at least the first object 502, which the partitioning information 216 identifies as a salient object, is completely encompassed by the first tile 602. Stated differently, the first object is included within the first tile 602 without spanning across multiple tiles. A similar process is performed if the partitioning data 218 indicates that the video frame 500 comprises an ROI. In at least some implementations, the content-aware partitioner 202 determines not to partition a video frame into multiple tiles based on its knowledge of the location of salient objects and considers the entire video frame as a single tile. For example, if an ROI(s) or salient object(s) covers the entire video frame or a portion of the video frame above a specified threshold, the content-aware partitioner 202, in at least some implementations, determines to maintain the video frame as a single tile.

It should be understood that the tiles can be vertical tiles (e.g., height is greater than width), horizontal tiles (width is greater than height), square tiles (height and width are equal), or the like. Also, the size, shape, and number of tiles can vary between frames depending on how the content-aware partitioner 202 decides to partition the video frame based on the partitioning data 218. If the content-aware partitioner 202 is configured to further partition tiles into blocks, the same process described above with respect to FIG. 5 and FIG. 6 is performed. For example, the tiles are further partitioned into blocks such that a salient object or ROI is included within a block in its entirety, or at least a majority of the object/ROI is included within a single block. By partitioning the video frame into tiles (or blocks) in a content-aware fashion, the content-aware partitioner 202 minimizes compression artifacts occurring within an object itself, which improves the quality of video perceived by the end-viewer. Also, by grouping objects together within divisions (tiles or blocks), more efficient compression is achievable for the same level of quality since, for example, the objects are more likely to share similarities in terms of colors, motion vectors, textures, etc.

After the video frame 500 has been partitioned, the encoder 112 selects a suitable encoding mode for each tile (or block). Each tile (or block) is then encoded based on the selected encoding mode and inserted into an encoded bitstream 114. The encoded bitstream 114 is transmitted to the destination device 104 via the connection 106. The decoder 116 then decodes the encoded bitstream 114 to generate a recovered sequence 118 of video frames, which then may be presented at a display 120, stored at a storage device 122, re-encoded for transmission to yet another device or for storage, and the like.

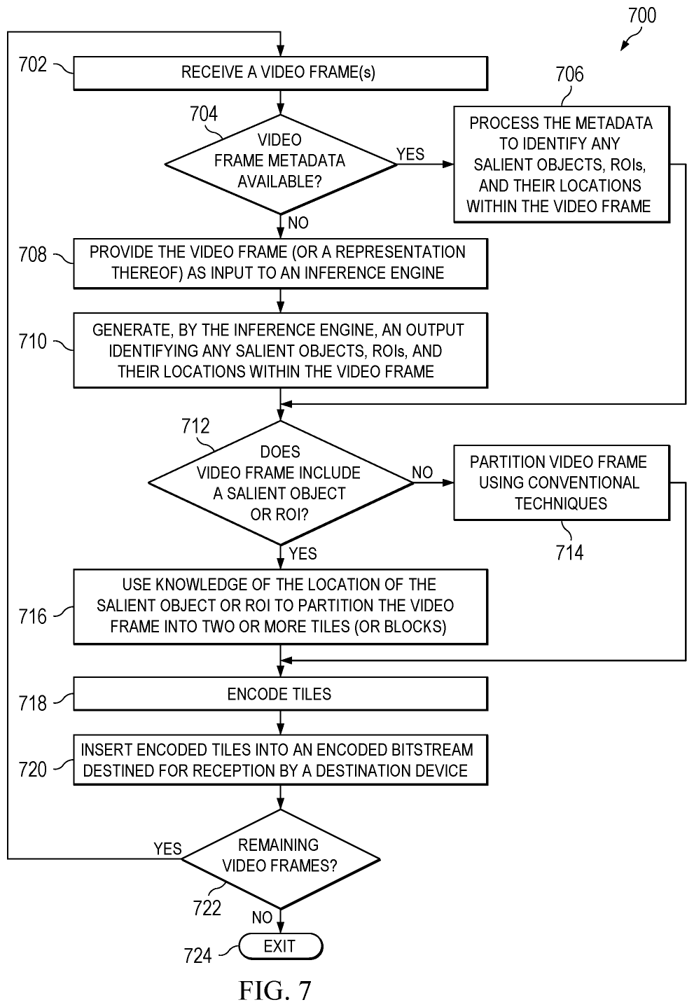

FIG. 7 illustrates a flow diagram of a method 700 for performing content-aware partitioning of a video frame. It should be understood that the processes described below with respect to method 700 have been described above in greater detail with reference to FIG. 1 to FIG. 6. For purposes of description, the method 600 is described with respect to an example implementation at the source device 102 of FIG. 1, but it will be appreciated that, in other implementations, the method 700 is implemented at processing devices having different configurations. Also, the method 700 is not limited to the sequence of operations shown in FIG. 7, as at least some of the operations can be performed in parallel or in a different sequence. Moreover, in at least some implementations, the method 700 can include one or more different operations than those shown in FIG. 7.

At block 702, the encoder 112 receives one or more video frames 301 generated by a video (or image) source 108. At block 704, the encoder 112 determines if video frame metadata 208 is available for the video frame 301. At block 706, if video frame metadata 208 is available, the encoder 112 processes the video frame metadata 208 to identify any salient objects or ROIs within the video frame 301 and their locations. The method 700 then continues to block 712, described below. At block 708, if video frame metadata 208 is not available for the video frame 301, the encoder 112 provides the video frame 301 (or a representation thereof) to an inference engine 312. At block 710, the inference engine 312 generates an output 305 identifying any salient objects or ROIs within the video frame 301 and their locations. It should be understood that, in at least some implementations, the processes at blocks 708 and 710 are not performed. In these implementations, the method 700 continues to 714 if video frame metadata 208 is not available for the video frame 301. In other implementations, the processes at blocks 704 and 706 are not performed.

At block 712, the encoder 112 determines if the video fame 301 includes any salient objects or ROIs based on processing the video frame metadata 208, the inference output 305, or a combination thereof. At block 714, if the video fame 301 does not include any salient objects or ROIs, conventional video frame partitioning techniques are performed. The method continues to block 718, described below. At block 716, if the video frame 301 includes a salient object or ROI, the encoder 112 uses its knowledge or awareness of the salient object or ROI, such as the object/ROI location, shape, type, a combination thereof, or the like, to partition the video frame 301 into a plurality of tiles (or blocks), such as two or more tiles (or blocks). As described above with respect to FIG. 1 to FIG. 4, the video frame 301 is partitioned such that an identified salient object or ROI is included within a single tile in its entirety or at least a majority (more than half of an amount above a specified threshold) of the salient object or ROI is included within a single tile and does not span across multiple tiles. In at least some implementations, one or more salient objects (or non-salient objects) or ROIs are grouped together within divisions (either tiles or blocks). In at least some implementations, the encoder 112 determines not to partition the video frame 301 into multiple tiles, such as when an ROI(s) or salient object(s) covers the entire video frame 301. In at least some embodiments, if a first salient object or ROI has been identified and there is an additional object(s) or region(s) in the video frame, the encoder 112 determines or identifies if the additional object(s) or region(s) is salient or non-salient, and uses this information to determine how to partition the video frame 301.

At block 718, the encoder 112 selects a suitable encoding mode for each tile (or block) and encodes tiles (or blocks). In implementations where the encoder 112 determines not to partition the video frame 301 into multiple tiles, the encoder 112 encodes the entire frame as a single tile. At block 720, the encoder 112 inserts the encoded tile or tiles into an encoded bitstream 114 destined for reception by a destination device 104. At block 722, the encoder 112 determines if any video frames 301 remain, such as for the sequence 110. If so, the method 700 returns to block 702. If all video frames 301 have been processed by the encoder 112, the method 700 exits at block 724.

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
receiving a video frame; and
responsive to the video frame comprising at least one of a salient object or a region of interest, partitioning the video frame into one or more tiles based on a location of the at least one of the salient object or the region of interest.

2. The method of claim 1, further comprising:
receiving metadata associated with the video frame, the metadata at least indicating the location of the at least one of the salient object or the region of interest in the video frame.

3. The method of claim 2, wherein the location indicated by the metadata includes pixel coordinates in the video frame.

4. The method of claim 1, further comprising:
generating, by an inference engine, an output identifying the at least one of the salient object or the region of interest and the location of the at least one of the salient object or the region of interest in the video frame.

5. The method of claim 4, wherein generating the output further comprises:
identifying at least one of an additional object or a region in the video frame; and
indicating at least one of that the additional object is a non-salient object or that the region is not of interest.

6. The method of claim 1, wherein partitioning the video frame into the one or more tiles comprises:
partitioning the video frame such that the at least one of the salient object or the region of interest is entirely within a single tile of the one or more tiles.

7. The method of claim 1, wherein partitioning the video frame into the one or more tiles comprises:
partitioning the video frame such that at least a portion of the at least one of the salient object or the region of interest that is above a specified threshold is entirely within a single tile of the one or more tiles.

8. The method of claim 1, wherein partitioning the video frame into the one or more tiles comprises:
grouping the at least one of the salient object or the region of interest with at least one of an additional salient object or an additional region of interest to form at least one of a group of salient objects or a group of regions of interest; and
partitioning the video frame such that the at least one of the group of salient objects or the group of regions of interest is entirely within a single tile of the one or more tiles.

9. The method of claim 1, further comprising:
encoding the one or more tiles using one at least one encoding technique;
inserting the encoded one or more tiles into an encoded bitstream; and
transmitting the encoded bitstream to a destination device.

10. A processing device comprising:
a video encoder configured to:
receive a video frame; and
responsive to the video frame comprising at least one of a salient object or a region of interest, partition the video frame into one or more tiles based on a location of the at least one of the salient object or the region of interest.

11. The processing device of claim 10, wherein the video encoder is further configured to:
receive metadata associated with the video frame, the metadata at least indicating the location of the at least one of the salient object or the region of interest in the video frame.

12. The processing device of claim 11, wherein the location indicated by the metadata includes pixel coordinates in the video frame.

13. The processing device of claim 10, wherein the video encoder comprises an inference engine configured to:
responsive to receiving the video frame or a representation thereof, generate an output identifying the at least one of the salient object or the region of interest and the location of the at least one of the salient object or the region of interest in the video frame.

14. The processing device of claim 13, wherein the inference engine is further configured to:
identify at least one of an additional object or a region in the video frame; and
generate the output to further indicate at least one of that the additional object is a non-salient object or that the region is not of interest.

15. The processing device of claim 10, wherein the video encoder is configured to partition the video frame into the one or more tiles by:
partitioning the video frame such that the at least one of the salient object or the region of interest is entirely within a single tile of the one or more tiles.

16. The processing device of claim 10, wherein the video encoder is configured to partition the video frame into the one or more tiles by:
partitioning the video frame such that at least a portion of the at least one of the salient object or the region of interest that is above a specified threshold is entirely within a single tile of the one or more tiles.

17. The processing device of claim 10, wherein the video encoder is configured to partition the video frame into the one or more tiles by:
grouping the at least one of the salient object or the region of interest with at least one of an additional salient object or an additional region of interest to form at least one of a group of salient objects or a group of regions of interest; and
partitioning the video frame such that the at least one of the group of salient objects or the group of regions of interest is entirely within a single tile of the one or more tiles.

18. The processing device of claim 10, further comprising:
a processor; and
a video source configured to generate the video frame.

19. A processing device comprising:
a video encoder configured to:
receive a video frame;
responsive to determining that metadata is available for the video frame, process the metadata to identify at least one of a salient object or a region of interest in the video frame;
responsive to determining that metadata is not available for the video frame, process the video frame or a representation thereof using at least one trained machine learning model to generate an output identifying the at least one of the salient object or the region of interest in the video frame; and
partition the video frame into one or more tiles based on a location of the at least one of the salient object or the region of interest.

20. The processing device of claim 19, wherein the video encoder is configured to partition the video frame into the one or more tiles by:
partitioning the video frame such that the at least one of the salient object or the region of interest is entirely within a single tile of the one or more tiles.
of interest is entirely within a single tile of the one or more tiles.
